(19) United States
(12) Patent Application Publication
(10) Pub. No.: US 2006/0135084 A1
(43) Pub. Date: Jun. 22, 2006

(54) RF front-end matching circuits for a transceiver module with T/R switch integrated in a transceiver chip

(75) Inventor: Chien-Kuang Lee, Hsinchu County (TW)

Correspondence Address: BIRCH STEWART KOLASCH & BIRCH, PO BOX 747, FALLS CHURCH, VA, 22040-0747, US

(73) Assignee: Airoha Technology Corp.

(21) Appl. No.: 11/260,135

(22) Filed: Oct. 28, 2005

(30) Foreign Application Priority Data
Dec. 22, 2004 (TW) 93140025

(51) Int. Cl. H04B 1/44

(52) U.S. Cl. 455/78

(57) ABSTRACT

Radio frequency front-end matching circuits suitable for a transceiver module with TR switch integrated in a transceiver chip. The radio frequency front-end transceiver module comprises a radio frequency (RF) front-end device, a transmit/receive (TR) switch, a transmitter, a receiver and an internal matching circuit, in which the TR switch, the receiver, the transmitter and the matching circuit are integrated in one chip. The internal matching circuit is disposed at the first signal transmission path or the second signal transmission path selectively. The internal matching circuit is connected between the TR switch and the receiver when disposed at the first signal transmission path (receiving path) or between the TR switch and the transmitter when disposed at the second signal transmission path (transmitting path), such that the RF front-end device is impedance matched to both the receiver and the transmitter.

### BACKGROUND

The invention relates to radio frequency front-end matching circuits for a transceiver, and more particularly, to radio frequency (RF) front-end matching circuits having a transceiver chip with an integrated transmit/receiver switch and a matching circuit.

FIG. 1A shows a conventional radio frequency (RF) front-end transceiver module. As shown, the RF front-end transceiver module is disposed on a print circuit board (PCB) 10, and comprises an antenna ANT, first to third external matching circuits 12a-12c, a transmit/receiver switch (TR is switch) 14, a receiver 162 and a transmitter 164, in which the receiver 162 and the transmitter 164 are integrated into a chip 16. For optimum performance, the antenna ANT is impedance matched to the transmitter 164 by the first and third external matching circuits 12a and 12c when transmitting signals and the antenna ANT should also be impedance matched to the receiver 162 by the first and second external matching circuits 12a and 12b when receiving signals. If the antenna ANT is not impedance matched to the transmitter 164 and the receiver 162 when transmitting and receiving signals, signal reflection may occur, and thus, causing more signal loss. FIG. 1B shows another conventional radio frequency (RF) front-end transceiver module. In the RF front-end transceiver module 100′, antenna ANT1 or antenna ANT2 is selected by a dual pole dual throw (DPDT) TR switch 14′ rather than a single pole dual throw (SPDT) TR switch. The operation of the radio frequency (RF) front-end transceiver module 100′ is similar to that of the front-end transceiver module 100 shown in FIG. 1A, and thus is omitted for simplicity.

FIG. 2 shows another conventional RF front-end transceiver module. In RF front-end transceiver module 200, TR switch 14 is integrated into a transceiver chip 16′ to decrease elements on the print circuit board 20, and thus, PCB area of the transceiver module can be reduced. As the TR switch 14 is integrated into the transceiver chip 16′, the chip pin count increases and it also becomes more difficult to do the PCB layout because of the traces of matching circuits 22a-22c would go in and out of the chip 16′. To solve such problem, the external matching circuits 22b and 22c and the TR switch 14 can be integrated into the transceiver chip 16′ at the same time. However, because the Q value of the passive components inside the chip is not high enough, any matching circuit integrated into the transceiver chip will have larger loss than external matching circuit. Therefore, if both matching circuits 22b and 22c are integrated into the transceiver chip, there will have more loss on both transmitter and receiver. Besides, because two matching circuits integrated into the chip, the chip area will be greatly increased.

### SUMMARY

Embodiments of a radio frequency front-end matching circuit suitable for a transceiver module with TR switch integrated in a transceiver chip are disclosed. The radio frequency (RF) front-end transceiver module comprises a RF front-end device (eg. antenna), a transmit/receive (TR) switch, a transmitter, a receiver and a matching circuit. The TR switch, the receiver, the transmitter and the matching circuit are integrated in one chip. The RF front-end device can be an antenna or filter or any device that connects to the RF single pin of the transceiver chip. The matching circuit is disposed at the first signal transmission path or the second signal transmission path selectively. The matching circuit is connected between the TR switch and the receiver when disposed at the first signal transmission path (receiving path) or is connected between the TR switch and the transmitter when disposed at the second signal transmission path (transmitting path), such that the RF front-end device (eg. antenna) is impedance matched to both the receiver and the transmitter.

The invention also discloses embodiments of a RF front-end matching circuit suitable for a transceiver module with TR switch integrated in a transceiver chip, in which the input impedance of the first signal transmission path (receiving path) and the output impedance of the second signal transmission path (transmitting path) are both impedance matched to the RF front-end device.

### DESCRIPTION OF THE DRAWINGS

The invention can be more fully understood by the subsequent detailed description and examples with reference made to the accompanying drawings, wherein:

FIG. 1A shows a conventional radio frequency front-end transceiver with conventional matching circuit;

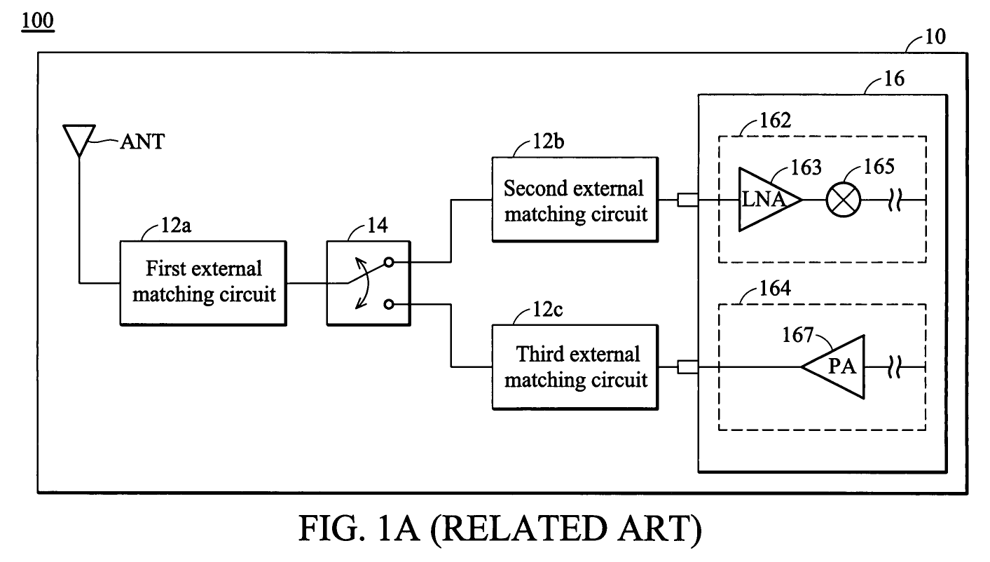

FIG. 1B shows another conventional radio frequency front-end transceiver with another conventional matching circuit;

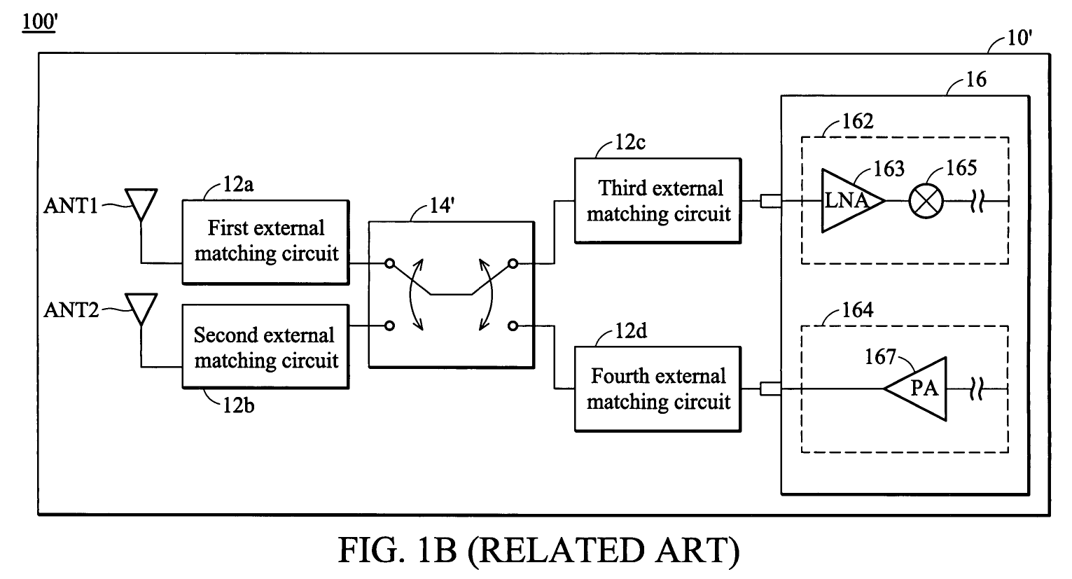

FIG. 2 shows another conventional radio frequency front-end transceiver with another conventional matching circuit;

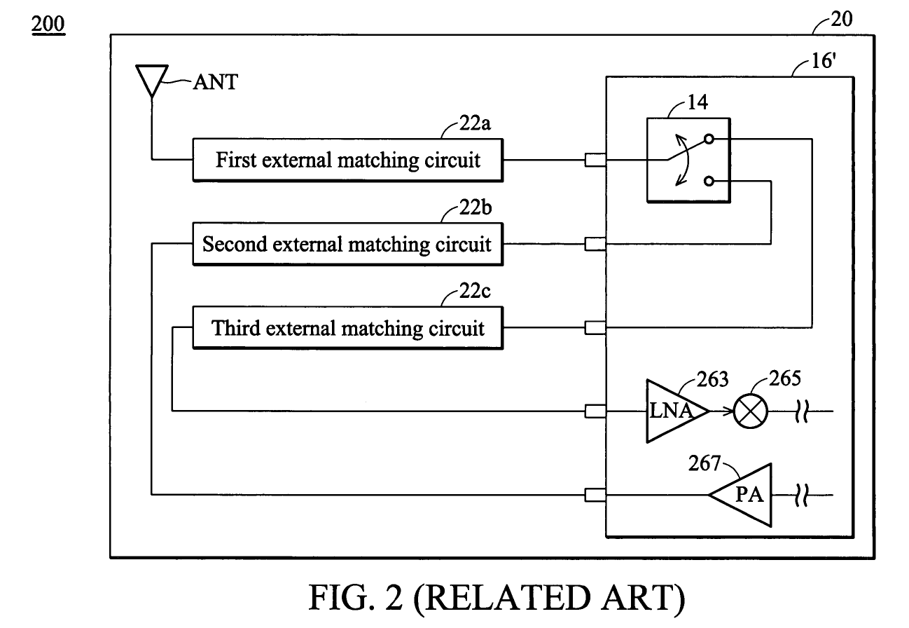

FIG. 3A shows an embodiment of a radio frequency front-end transceiver with proposed matching circuit;

FIG. 3B shows another embodiment of a radio frequency front-end transceiver with another proposed matching circuit; and

FIG. 3C shows another embodiment of a radio frequency front-end transceiver with another proposed matching circuit.

### DETAILED DESCRIPTION

### First Embodiment

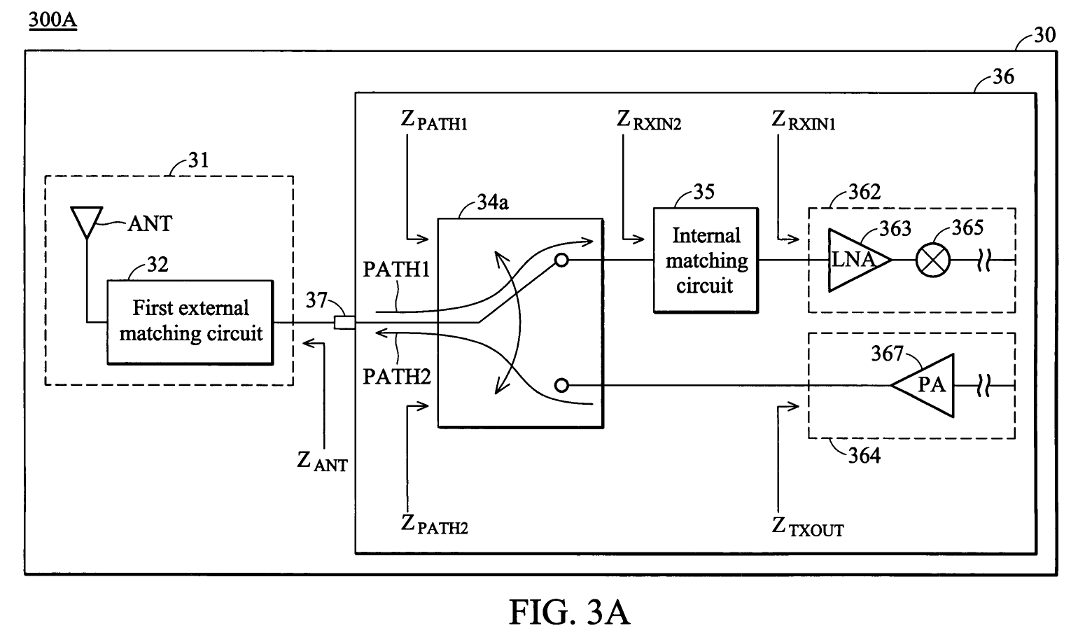

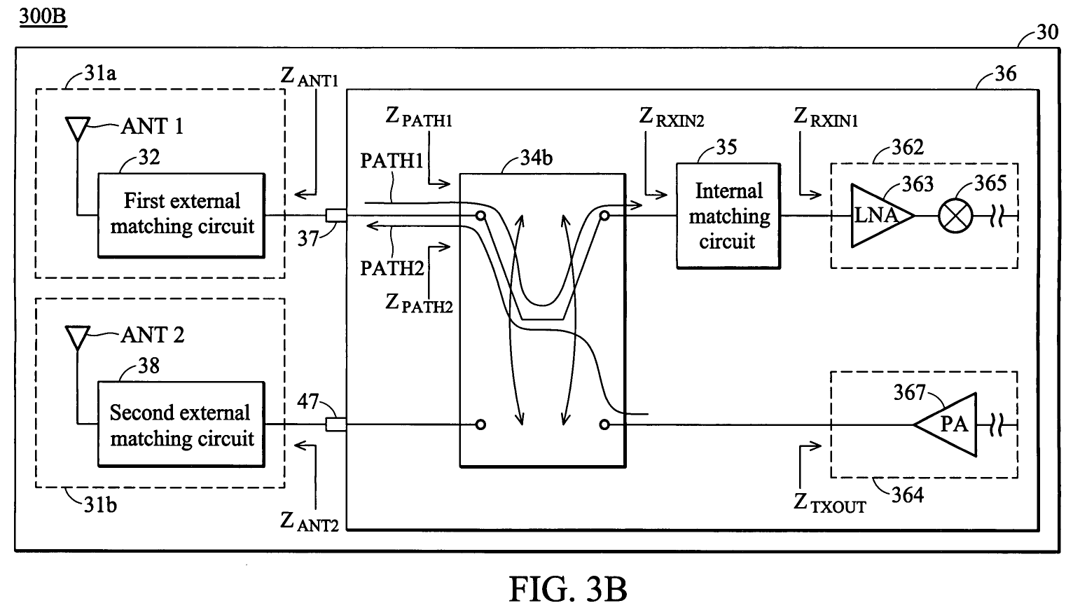

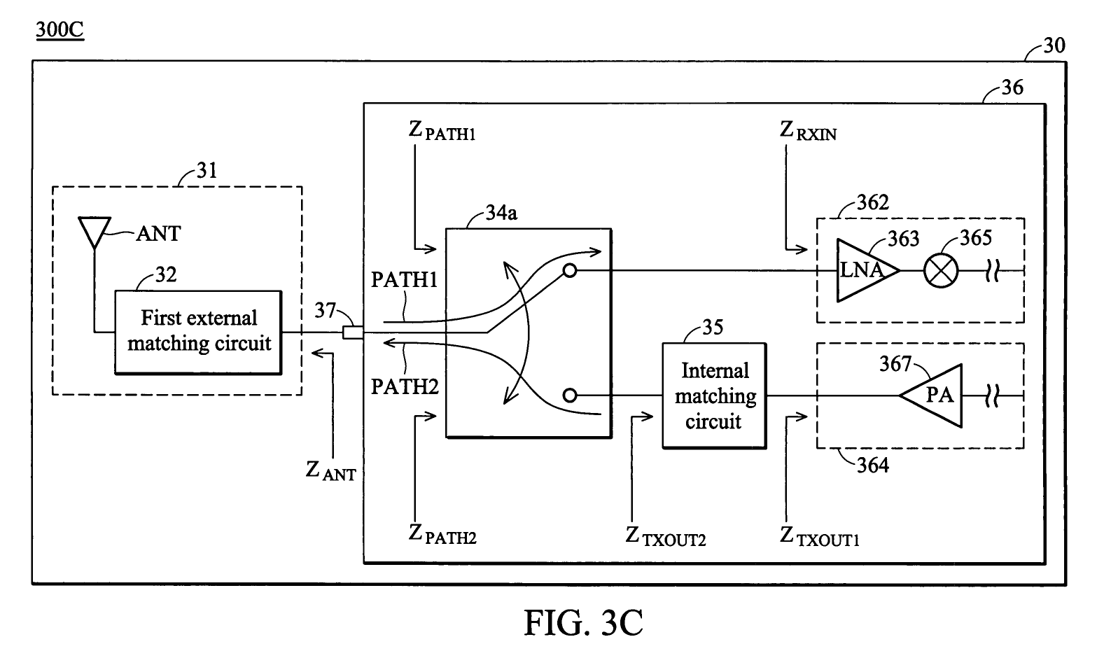

FIG. 3A shows an embodiment of a radio frequency (RF) front-end matching circuit suitable for a transceiver module with TR switch integrated in a transceiver chip. As shown, the radio frequency front-end transceiver module 300A is disposed on a print circuit board 30, and comprises an antenna device 31 and a transceiver chip 36. The antenna device 31 can be regarded as a radio frequency front-end device and comprises an antenna ANT and an external matching circuit 32. The transceiver chip 36 comprises a transmit/receiver (TR) switch 34a, an internal matching circuit 35, a receiver 362 and a transmitter 364. The receiver 362 comprises at least a low noise amplifier (LNA) 363 and a mixer 364, to receive RF signals through the antenna device 31. For example, the LNA 363 amplifies the received RF signals, and the mixer 364 converts the amplified radio frequency (RF) signals to intermediate frequency (IF) signals or baseband frequency signals. The transmitter 364 comprises at least a power amplifier (PA) or a driver amplifier, to transmit RF signals by the antenna device 31.

The TR switch 34a can be a single pole dual throw (SPDT) TR switch, connected to the antenna device 31 through a pin 37 of the chip 36. The TR switch 34a can selectively enable a first signal transmission path (reception path) PATH1 or a second signal transmission path (transmit path) PATH2 selectively. The TR switch 34a enables the first signal transmission path PATH1 to connect the antenna device 31 and the receiver 362 or the second signal transmission path PATH2 to connect the antenna device 31 and the transmitter 364 when the transceiver attempts to receive or transmit signals.

Because the first external matching circuit 32 is shared by both signal paths PATH1 and PATH2, impedances of PATH1 and PATH2 thereof at the pin 37 connected to the first external matching circuit 32 are required to be closed. Namely, the impedance Z_{PATH1} of the first signal transmission path PATH1 is required to be close to the impedance Z_{PATH2} of the second signal transmission path PATH2, Z_{PATH1}≈Z_{PATH2}. The first external matching circuit 32 is disposed between TR switch 34a and antenna such that the antenna device 31 can be impedance matched to the impedance of pin 37 of the transceiver.

When the TR switch 34a is symmetrical, insertion loss and impedance of the first transmission path of the switch are similar to those of the second transmission path of the switch, and the impedance Z_{RXIN2} is designed to be close to the impedance Z_{TXOUT} in the chip 36.

The matching circuit 35 is disposed at the first signal transmission path PATH1 and connected between the TR switch 34a and the receiver 362, such that the input impedance Z_{RXIN1} can be adjusted to the impedance Z_{RXIN2}, which is close to impedance Z_{TXOUT}. Thus, the impedance Z_{PATH1}≈impedance Z_{PATH2} when the TR switch 34a is symmetrical.

Further, the impedance Z_{ANT} of the antenna device 31 can be impedance matched to the impedance Z_{PATH1} or the impedance Z_{PATH2} by the external matching circuit 32. Because impedance Z_{PATH1}≈impedance Z_{PATH2}, the impedance Z_{ANT} of the antenna device is then impedance matched to both the impedance Z_{PATH1} and Z_{PATH2}. For example, the matching circuits 32 and 35 can comprise transformers, resistors, capacitors, inductors and the like.

When transmitting RF signals, the output impedance Z_{TXOUT} is converted to impedance Z_{PATH2}, impedance matched to the impedance Z_{ANT} of the antenna device 31 due to selection of the TR switch 34a. Alternately, due to selection of the TR switch 34a, the input impedance Z_{RXIN1} is adjusted to the impedance Z_{RXIN2} and is converted to impedance Z_{PATH1}, also impedance matched to the impedance Z_{ANT} of the antenna device 31 when receiving RF signals. Thus, impedance can be matched by the same external matching circuit 32 when receiving and transmitting signals, and the external circuits outside the chip 36 can be simplified.

When the TR switch 34a is not symmetrical, the internal matching circuit 35 is designed such that the impedance Z_{PATH1} of the first signal transmission path PATH1 is close to the impedance Z_{PATH2} of the second signal transmission path PATH2. The external matching circuit 32 is designed to match the impedance Z_{ANT} of the antenna device 31 to the impedance Z_{PATH1} or the impedance Z_{PATH2}, because the impedance Z_{PATH1}≈impedance Z_{PATH2}, the impedance Z_{ANT} is then impedance matched to both the impedances Z_{PATH1} and Z_{PATH2}.

Thus, because only one matching circuit outside the transceiver chip is required, simplified circuit designs for whole transceiver module are obtained, such that layout area of print circuit board can be conserved. Further, because only one matching circuit is required inside the transceiver chip, extra signal loss can be avoided at another signal transmission path. That is, if the internal matching circuit is disposed on the receiver path, there will be no extra matching loss on the transmitter path. If the internal matching circuit is disposed on the transmitter path, there will be no extra matching loss on the receiver path. Therefore, larger signal loss caused by two matching circuits integrated simultaneously inside the conventional chip is prevented and chip area is also reduced. Moreover, because the TR switch is integrated into the transceiver chip and a common pin is shared by both transmitter and receiver, pin count of the transceiver chip is also reduced.

### Second Embodiment

FIG. 3B shows another embodiment of a radio frequency front-end matching circuit suitable for a transceiver module with TR switch integrated in a transceiver chip. As shown, the radio frequency front-end module 300B is similar to the transceiver module 300A shown in FIG. 3A, with exception of two antenna devices 31a and 31b and TR switch 34b. In the radio frequency front-end transceiver module 300B, TR switch 34b is a dual pole dual throw (DPDT) TR switch, rather than the single pole dual throw (SPDT) TR switch shown in FIG. 3A, selecting the antenna device 31a or the antenna device 31b. The antenna devices 31a and 31b can each be regarded as a radio frequency front-end device, the antenna device 31a comprising an antenna ANT1 and a first external matching circuit 32 and antenna device 31b comprising an antenna ANT2 and a second external matching circuit 38.

Because the first external matching circuit 32 is shared by signal paths PATH1 and PATH2, impedances of signal paths PATH1 and PATH2 at the pin 37 connected to the first external matching circuit 32 are required to be closed. Namely, the impedance Z_{PATH1} of the first signal transmission path PATH1 is required to be close to the impedance Z_{PATH2} of the second signal transmission path PATH2, Z_{PATH1}≈Z_{PATH2}. The first external matching circuit 32 is disposed between TR switch 34b and the antenna ANT1 such that the antenna device 31 is matched to the impedance of pin 37 of the transceiver. Similarly, the antenna device 31b can also be matched to the impedance of pin 47 of the transceiver.

When the TR switch 34b is symmetrical, insertion loss and impedance of the first signal transmission path of the switch are similar to those of the second signal transmission path of the switch, and the impedance Z_{RXIN2} is designed to be close to the impedance Z_{TXOUT} in the transceiver chip 36.

The matching circuit 35 is disposed at the first signal transmission path PATH1 and connected between the TR switch 34b and the receiver 362. The input impedance Z_{RXIN1} can be adjusted to the impedance Z_{RXIN2}, which is close to impedance Z_{TXOUT}. Thus, the impedance Z_{PATH1}≈impedance Z_{PATH2} when the TR switch 34b is symmetrical. By the first external matching circuit 32, the impedance Z_{ANT1} of the antenna device 31a can be matched to the impedance Z_{PATH1} or the impedance Z_{PATH2}. Due to impedance Z_{PATH1}≈impedance Z_{PATH2}, the impedance Z_{ANT1} is then matched to both the impedance Z_{PATH1} and Z_{PATH2}.

When transmitting RF signals, the output impedance Z_{TXOUT} is converted to impedance Z_{PATH2}, impedance matched to the impedance Z_{ANT1} of the antenna device 31a due to selection of the TR switch 34b. Alternately, due to selection of the TR switch 34b, the input impedance Z_{RXIN1} is adjusted to the impedance Z_{RXIN2} and is converted to impedance Z_{PATH1}, also impedance matched to the impedance Z_{ANT1} of the antenna device 31a when receiving RF signals. Thus, impedances can be matched by the same external matching circuit 32 when receiving and transmitting signals, and the external circuits outside the transceiver chip 36 can be simplified.

When the TR switch 34b is not symmetrical, the internal matching circuit 35 is designed such that the impedance Z_{PATH1} at the first signal transmission path PATH1 is close to the impedance Z_{PATH2} at the second signal transmission path PATH2. The external matching circuit 32 is designed to match the impedance Z_{ANT1} of the antenna device 31a to the impedance Z_{PATH1} or the impedance Z_{PATH1}, because the impedance Z_{PATH1}≈impedance Z_{PATH2}, the impedance Z_{ANT1} is impedance matched to both the impedance Z_{PATH1} and Z_{PATH2}. Thus, impedance can be matched by the same external matching circuit 32 when receiving or transmitting signals, and the external circuits outside the transceiver chip 36 can be simplified. Similarly, by TR switching 34b selecting, antenna device 31b can also be impedance matched to both receiver and transmitter by the same external matching circuit 38 when receiving or transmitting signals.

### Third Embodiment

FIG. 3C shows another embodiment of a radio frequency front-end matching circuit suitable for a transceiver module with TR switch integrated in a transceiver chip. As shown, the radio frequency front-end module 300C is similar to the circuit 300A shown in FIG. 3A, with exception of the internal matching circuit 35 being disposed at the second signal transmission path PATH2 to connect the TR switch 34a and the transmitter 364.

Because the first external matching circuit 32 is shared by signal paths PATH1 and PATH2, impedances of signal paths PATH1 and PATH2 at the pin 37 connected to the first external matching circuit 32 are required to be closed. Namely, the impedance Z_{PATH1} of the first signal transmission path PATH1 is required to be close to the impedance Z_{PATH2} of the second signal transmission path PATH2, Z_{PATH1}≈Z_{PATH2}. The first external matching circuit 32 is disposed between TR switch 34a and the antenna ANT, such that the antenna device 31 is matched to the impedance of pin 37 of the transceiver.

When the TR switch 34a is symmetrical, the insertion loss and impedance of the first signal transmission path of the switch are similar to those of the second signal transmission path of the switch, and the impedance Z_{TXOUT2} is designed to be close to the impedance Z_{RXIN} in the chip 36.

The matching circuit 35 is disposed at the second signal transmission path PATH2 and connected between the TR switch 34a and the transmitter 364. The output impedance Z_{TXOUT1} can be adjusted to the impedance Z_{TXOUT2}, which is closed to impedance Z_{RXIN}. Thus, the impedance Z_{PATH1}≈impedance Z_{PATH2} when the TR switch 34a is symmetrical. By the external matching circuit 32, the impedance Z_{ANT} of the antenna device 31 can be matched to the impedance Z_{PATH1} or the impedance Z_{PATH2}. Due to impedance Z_{PATH1}≈impedance Z_{PATH2}, the impedance Z_{ANT} is then matched to both the impedance Z_{PATH1} and Z_{PATH2}. For example, the matching circuits 32 and 35 can comprise transformers, resistors, capacitors, inductors and the like.

When receiving RF signals, the input impedance Z_{RXIN} of the receiver 362 is converted to impedance Z_{PATH1}, impedance matched to the impedance Z_{ANT} of the antenna device 31 due to selection of the TR switch 34a. Alternately, due to selection of the TR switch 34a, the output impedance Z_{TXOUT1} of the transmitter 364 is adjusted to the impedance Z_{RXOUT2} and is converted to impedance Z_{PATH2}, also impedance matched to the impedance Z_{ANT} of the antenna device 31 when transmitting signals. Thus, impedances can be matched by the same external matching circuit 32 when receiving and transmitting signals, and the external circuits outside the transceiver chip 36 can be simplified.

When the TR switch 34a is not symmetrical, the internal matching circuit 35 is designed such that the impedance Z_{PATH2} at the second signal transmission path PATH2 is close to the impedance Z_{PATH1} at the first signal transmission path PATH1. The external matching circuit 32 is designed to match the impedance Z_{ANT} of the antenna device 31 to the impedance Z_{PATH1} or the impedance Z_{PATH2}. Because the impedance Z_{PATH1}≈impedance Z_{PATH2}, the impedance Z_{ANT} is matched to both the impedance Z_{PATH1} and Z_{PATH2}. Thus, impedance can be matched by the same external matching circuit 32 when receiving and transmitting signals, and the external circuits outside the transceiver chip 36 can be simplified.

Thus, because only one matching circuit outside the transmission chip is required, circuit designs for whole transceiver module, for example designs in external circuit, are simplified, such that layout area of printed circuit board is conserved. Further, because only one matching circuit is required inside the transceiver chip, extra signal loss can be avoided at another signal transmission path. That is, if the internal matching circuit is disposed on the transmitter path, there will be no extra matching loss on the receiver path. If the internal matching circuit is disposed on the receiver path, there will be no extra matching loss on the transmitter path. Therefore, larger signal loss caused by two matching circuits integrated simultaneously inside the conventional transceiver chip is prevented and chip area is also reduced. Moreover, because the TR switch is integrated into the transceiver chip and a common pin is shared by both transmitter and receiver, pin count of the transceiver chip is also reduced.

The invention utilizes a transceiver chip integrated with a TR switch. In selection of matching circuit, unlike convention structure in which transmitter and receiver each requires a matching circuit, the invention requires only one internal matching circuit inside the transceiver chip. The invention also simplifies external circuits on the printed circuit board (PCB) module because of only one external matching circuit is required to simultaneously match to both transmitter and receiver. It should be noted that the matching circuits integrated in the transceiver chip have a lower Q value, as compared with the matching circuits disposed on a printed circuit board (PCB). Although such lower Q value may degrade performance of the transceiver, noise figures (NF) and gain degradation caused by low Q matching components in receiver are usually more acceptable than power degradation in transmitter. Thus, in the radio frequency front-end matching circuit of the invention, the internal matching circuit is preferably disposed between TR switch and the receiver in the transceiver chip, and the external matching circuit can be impedance matched to the impedance of both transmitter and receiver.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A radio frequency front-end circuit suitable for a transceiver module, comprising:
a radio frequency (RF) front-end device;
a transmit/receive (TR) switch, enabling a first signal transmission path and a second signal transmission path selectively;
a transmitter;
a receiver; and
an internal matching circuit disposed at the first signal transmission path or the second signal transmission path selectively, wherein the TR switch, the receiver, the transmitter and the internal matching circuit are integrated in one chip, the internal matching circuit is connected between the TR switch and the receiver when disposed at the first signal transmission path and between the TR switch and the transmitter when disposed at the second signal transmission path.

2. The radio frequency front-end circuit as claimed in claim 1, wherein the TR switch is connected to the RF front-end device through one pin of the chip.

3. The radio frequency front-end circuit as claimed in claim 2, wherein an input impedance of the receiver is impedance matched to an impedance of the RF front-end device when the internal matching circuit is disposed at the first signal transmission path.

4. The radio frequency front-end circuit as claimed in claim 3, wherein an output impedance of the transmitter is impedance matched to the impedance of the RF front-end device.

5. The radio frequency front-end circuit as claimed in claim 2, wherein an output impedance of the transmitter is impedance matched to an impedance of the RF front-end device when the internal matching circuit is disposed at the second signal transmission path.

6. The radio frequency front-end circuit as claimed in claim 5, wherein an input impedance of the receiver is impedance matched to the impedance of the RF front-end device.

7. The radio frequency front-end circuit as claimed in claim 2, wherein the RF front-end device comprises an antenna and an external matching circuit connected between the antenna and one pin of the chip.

8. The radio frequency front-end circuit as claimed in claim 1, wherein the transmitter comprises at least a driver amplifier.

9. The radio frequency front-end circuit as claimed in claim 1, wherein the transmitter comprises at least a power amplifier.

10. The radio frequency front-end circuit as claimed in claim 1, wherein the receiver comprises at least a low noise amplifier (LNA) and a mixer.

11. The radio frequency front-end circuit as claimed in claim 1, wherein the TR switch is a single pole dual throw (SPDT) switch or a dual pole dual throw (DPDT) switch.

12. A radio frequency front-end circuit suitable for a transceiver module, comprising:
a transmit/receive (TR) switch, enabling a first signal transmission path and a second signal transmission path selectively;
a transmitter;
a receiver;
a radio frequency (RF) front-end device; and
an internal matching circuit disposed at the first signal transmission path or the second signal transmission path selectively, wherein the TR switch, the receiver, the transmitter and the internal matching circuit are integrated in one chip, the internal matching circuit is connected between the TR switch and the receiver when disposed at the first signal transmission path and is connected between the TR switch and the transmitter when disposed at the second signal transmission path, such that an input impedance of the first signal transmission path and an output impedance of the second signal transmission path are closed and both impedance matched to the RF front-end device.

13. The radio frequency front-end circuit as claimed in claim 12, wherein the TR switch is connected to the RF front-end device through a pin of the chip.

14. The radio frequency front-end circuit as claimed in claim 13, wherein the input impedance of the first signal transmission path is impedance matched to an impedance of the RF front-end device when the internal matching circuit is disposed at the first signal transmission path.

15. The radio frequency front-end circuit as claimed in claim 14, wherein the output impedance of the second signal transmission path is impedance matched with to an impedance of the RF front-end device.

16. The radio frequency front-end circuit as claimed in claim 13, wherein the output impedance of the second signal transmission path is impedance matched to impedance of the RF front-end device when the internal matching circuit is disposed at the second signal transmission path.

17. The radio frequency front-end circuit as claimed in claim 16, wherein an input impedance of the first signal transmission path is impedance matched to the impedance of the RF front-end device.

18. The radio frequency front-end circuit as claimed in claim 13, wherein the RF front-end device comprises an antenna and an external matching circuit connected between the antenna and the pin of the chip.

19. The radio frequency front-end circuit as claimed in claim 12, wherein the transmitter comprises at least a driver amplifier.

20. The radio frequency front-end circuit as claimed in claim 12, wherein the transmitter comprises at least a power amplifier.

21. The radio frequency front-end circuit as claimed in claim 12, wherein the receiver comprises at least a low noise amplifier (LNA) and a mixer.

22. The radio frequency front-end circuit as claimed in claim 12, wherein the TR switch is a single pole dual throw (SPDT) TR switch or a dual pole dual throw (DPDT) TR switch.
